(19) United States
(12) Patent Application Publication
(10) Pub. No.: US 2011/0208659 A1
(43) Pub. Date: Aug. 25, 2011

(54) METHOD AND APPARATUS FOR MAKING SECURE TRANSACTIONS USING AN INTERNET ACCESSIBLE DEVICE AND APPLICATION

(75) Inventors: Frank Easterly, Midlothian, VA (US); Clifford Mason, Columbus, GA (US)

(73) Assignee: Last Mile Technologies, LLC, Richmond, VA (US)

(21) Appl. No.: 13/101,317

(22) Filed: May 5, 2011

Related U.S. Application Data
(63) Continuation-in-part of application No. 12/109,960, filed on Apr. 25, 2008.
Application No. 12/109,960 is a continuation-in-part of application No. 11/464,694, filed on Aug. 15, 2006, now abandoned.
(60) Provisional application No. 61/331,469, filed on May 5, 2010.
(60) Provisional application No. 60/913,964, filed on Apr. 25, 2007.
(60) Provisional application No. 60/915,139, filed on May 1, 2007.

(51) Int. Cl. G06Q 20/00

(52) U.S. Cl. 705/79

(57) ABSTRACT

A method for making financial transactions uses a proprietary server and network in communication with a merchant's point of sale (POS) terminal and a customer's smart phone. The smart phone runs an application that generates or downloads from the server a two dimensional barcode containing encrypted information. The barcode display is scanned at the POS, and transaction information is returned to the proprietary server for processing as an ACH or a conventional transaction.

### CROSS REFERENCE TO RELATED APPLICATIONS

This application claims benefit under 35 U.S.C. §119(e) to U.S. Provisional Application Ser. No. 61/331,469, filed May 5, 2010. This application is also a Continuation-in-Part of U.S. application Ser. No. 12/109,960, filed Apr. 25, 2008, which is a Continuation-in-Part of application Ser. No. 11/464,694, filed Aug. 15, 2006, in addition to claiming the benefit under 35 U.S.C. §119(e) of Provisional Application No. 60/913,964, filed Apr. 25, 2007 and Provisional Application No. 60/915,139, filed May 1, 2007. The disclosures of these applications are incorporated herein in their entirety by reference.

### FIELD OF THE INVENTION

The present invention relates to the facilitation of certain financial and nonfinancial transactions between customers, retailers and suppliers using smart devices. In particular, it relates to a method of making transactions using an application residing on a smart device to provide secure, encrypted communications with a proprietary server using scanable barcodes to authenticate the identity of the purchaser and authorize, clear and settle a transaction between the purchaser and a third party who may be a merchant.

### BACKGROUND OF THE INVENTION

The volume of electronic payment transactions executed with general purpose cards such as credit cards, debit cards, both “online” and “offline”, and ATM cards at the point of sale (“POS”) account for 28.5% of consumer spending in 2005 up from 12.6% in 1995. The system for executing electronic transactions is currently determined by card issuing banks, card associations, EFT networks and processors which charge substantial fees for processing these transactions in the form of interchange. Today's card payment networks are grossly inefficient and layered with cost. Each time a card association, EFT network or processor touches a transaction they add fees in the form of interchange. Those transaction fees are borne by the merchant, passed on to the customer and continue to rise. United States interchange fees have increased 29% since 1995. At present the transaction fee paid by the merchant for a relatively moderate purchase of $100.00 can approach $3.00. It will be readily seen that given the already large and increasing percentage of POS sales that are executed using general purpose cards such as credit cards, debit cards and ATM cards, these transaction fees have a significant impact on merchant profitability. Since a greater number of transactions are subject to interchange fees the total cost of interchange to merchants have tripled in the last ten years. As the trend toward increasing usage of such payment mechanisms continues to rise, the transaction fees will similarly increase. In 2005 American merchants paid nearly $50 Billion to accept credit cards.

This presents a dilemma for merchants because while customers generally like the convenience of using such devices for completing purchases, the transactions continue to grow more costly. On average credit card transactions cost American Merchants six times as much as cash transactions and twice as much as checks or PIN based debit cards.

### Average Cost Per Transaction of Accepting Payments for U.S. Retailers in 2000

| | | Off-Line | | On-Line | |
|---|---|---|---|---|---|
| | Credit | (Signature) | | (PIN) | |
| | Cards | Debit Cards | Checks | Debit Cards | Cash |
| Average Cost | $0.72 | $0.72 | $0.36 | $0.34 | $0.12 |
| Per Transaction | | | | | |

Furthermore, while customers generally like using checks for payment, the use of checks has been in decline. In addition, checks are not as convenient as cards, hence their use has been in decline. Accordingly, there is a need to provide consumers and merchants with a real alternative to the disadvantages of the current methods of payment while preserving the advantage of payment by check.

Moreover, because conventional debit cards, credit cards and ATM cards are under the control of the issuing banks, card associations, EFT networks and processors merchants must comply with the dictates of these institutions and have no control over the processes. These merchant restraints are designed to restrict merchants' options as to what type of payment systems they can accept and how they can price them, and force merchants to bundle the pricing of payment systems with the underlying goods and services being sold. In effect, all consumers underwrite the increased costs of general purpose cards in the form of higher prices for all consumers, even those who pay by cash. Another disadvantage is that merchants have no ability to identify a specific customer by name, address, telephone number, e-mail address or other identifying data and link them to consumer purchase information within transaction related databases. Such information is of tremendous potential value to merchants as it may allow the tracking of transaction related data, so-called “basket metrics” and the relationship of that data to the specific customer. Basket-metrics can include information without limitation, such as item count, sales amount, demographics concerning customers and store location, responsiveness to promotions such as coupon or special promotion codes and customer related data concerning the purchase frequency, volume and value on a per customer basis over the lifetime of a shopping relationship. Without the ability to readily track that information and associate it to individual consumers whose names, addresses and other contact information is known, retailers lose the opportunity to directly target and market consumers on an individual basis.

Furthermore, as consumer purchases are currently effectuated, managing effective buyer loyalty or rewards programs is rendered difficult because such programs require the tracking of consumer purchases both in terms of number and volume. Unless merchants have an effective method for gathering, compiling and administering necessary transaction related data along with consumer specific data, reward and customer loyalty programs cannot effectively be managed.

In addition, merchants generally do not have access to consumer credit information including, of specific concern, readily accessible information regarding prior approvals or declines at the point of sale (“POS”). Occasionally a merchant will receive an approval from a credit card issuer only to later find out that the approval was based upon a “stand in” event when the customer's actual balance information was unavailable. Thus a merchant may complete a sales transaction only to have the transaction subsequently fail to close or be charged back. This occurs when a consumer is the victim of fraud, enters a dispute with their credit card company, or when a consumer with a poor credit history defaults, has insufficient funds, or otherwise precludes funding of the sales. Similarly, other customers may have an excessive rate of returns. That is, the customer may regularly purchase items but subsequently return them for a refund or other credit. Such customers may be considered less desirable or less profitable customers; information as to whom the merchant would like to be informed.

Finally, under current systems, managing effective consignment relationships is rendered difficult and time consuming as a result of the record keeping that must accompany such arrangements and the delays in settling accounts between the parties involved. Thus, for example, a supplier may be hesitant to enter into a consignment agreement because of the delays in receiving payments from merchants.

Accordingly, there is therefore a need for a retailer owned POS payment system which provides convenience to consumers, reduces and controls transaction costs for merchants, allows for the effective management of consignment relationships, and allows for merchant access to consumer transaction related information which the merchant can then use for a variety of purposes.

### SUMMARY OF THE INVENTION

The present invention provides a method for facilitating financial and related non-financial transactions between customers, retailers and suppliers engaged in commercial remittance transactions performed over the internet, over wired and wireless telephone networks, and over local area networks including but not limited to Bluetooth and WiFi systems. The system uses a proprietary network (a virtual private network) that interfaces with merchants who are registered to use the proprietary system (described hereinafter as the “eCache” system), which is the proprietary network and system that is referenced in this application and all prior patent applications from which priority is claimed, all of which are hereby incorporated in their entirety by reference. The transaction related data that the eCache system stores and accesses may be stored either within the merchant's own system or on eCache servers which are external to the merchant's system. The eCache server or servers have encryption means, storage, and a processor. The eCache decision making process may similarly occur within the merchant's system or on the eCache server or system of servers.

The eCache system bypasses conventional card processing infrastructure by providing and utilizing a link between the retailer's POS system and the ACH network. The Automated Clearing House (ACH) is a central clearing facility operated by a private organization or a Federal Reserve Bank (FRB) on behalf of Depositor Financial Institutions (DFIs). Participating DFIs transmit or receive ACH entries that allow for transactions to be funded from a customer checking account or a pooled account established for reward and loyalty transactions as an ACH transaction. International banks also participate in such bank to bank transfers using the International ACH (IAT) proprietary network. Users (as used herein, “users” and “customers” may be used interchangeably unless context dictates otherwise) are cross-referenced to bank accounts (demand deposit accounts, or ‘DDAs’) they control, and through which the user can make withdrawals, or settle accounts on the internet. Banks are identified using a bank identification number. An additional link allows general purpose cards such as credit cards, debit cards, charge cards, gift cards, and prepaid cards, to be switched to and authorized through a merchant processor network, association network, debit (EFT) network or ATM network, where they may be used to complete a sales transaction. General purpose card transactions and eCache transactions may be routed through a server resident within the merchant's POS or other systems at the merchant location.

An eCache server is a server that contains proprietary software that reviews transaction data to validate input data, link to internal or external databases, approve or decline transactions based upon a rules database applied to input data and its internal or external databases. The server also contains routing preference tables which allow a transaction to be routed to external debit or credit networks based upon the lowest cost of that transaction to a retailer. Coupons and reward programs may also be included in the routing tables, and used to determine the lowest cost of a transaction to a retailer. If desired, “split tender” choices can be made whereby a transaction is partially funded from any of two or more funding sources that may include coupons. The eCache server issues instructions to member banks that will be carried out on existing financial networks. In so doing, the eCache server can make predetermined choices for structuring the transaction, taking into consideration such factors as transactional costs charged by other financial networks for various types of transactions, the time for settlement of the transaction, and the finality and immediacy to be accorded the transaction in real time. The eCache server will instruct member banks to initiate monetary transfers. Such transfers may involve only internal bank transfers, or such instructions may involve initiating an ACH transfer of funds between banks. As a general rule, regardless whether the transfer will be an intrabank transfer or will transfer money from one bank to another, the transaction will be initiated as a preformatted ACH CCD, that is, a request to initiate an ACH transaction. In one embodiment of the invention, a preformatted ACH is sent to, or generated by, a smart device from which it may be transmitted for further processing at a merchant's POS or by the eCache server. The server also stores decision data to be transmitted to an external server for additional processing. Such additional processing may include batching approved transaction data to an external server for submission to the ACH network or to a credit or debit card network. The server also creates end-of-day settlement files that contain financial and non-financial data that are transmitted to external servers.

The VPN of this invention is hosted indirectly through member banks who are also directly connected to one of the ACH networks that provide banks with means to transfer funds between banks on behalf of their customers. The eCache server is a proprietary server and network that is operated by an eCache Operator. The eCache Operator is authorized by member banks or other financial or non-financial institutions (collectively referred to herein as “banks”) to originate ACH transactions with member banks on behalf of the banks' account holders through operating agreements with each member bank. When an operating agreement is executed with a bank, the eCache server establishes a discrete, secure network connection to that bank, and creates potential indirect access for all that bank's demand deposit account (DDA) customers to the eCache server.

The server may also be hosted externally by eCache. The server has the ability to distinguish between eCache transactions and general purpose card transactions. General purpose card transactions can be routed to selected merchant processors according to merchant established guidelines. eCache transactions can be approved or declined by the eCache server.

The eCache server connects the merchant retail inventory, POS and ACH networks and operates over existing retailer platforms. Depending on the degree of connectivity and the linkages between various retailer systems within a retailer's network environment, the eCache server may connect at one or multiple nodes. If, for example there are linkages between the merchant's POS system and inventory system, eCache may function by linking only to either the POS system or the inventory system. If the systems are not linked, depending on the functionality the retailer requires, the eCache server may link separately to the various systems of the retailer. It may further integrate inventory systems, barcode readers, SKU systems, POS terminals and other existing retailer information systems. By operating within the inventory system of the retailer or supplier, the system allows for the automatic recordation of a complete transaction record incorporating a wide variety of sales related data. In addition, through use of the consumer specific bar codes, data from each transaction may be related to the individual consumer and associated with demographic data that further identifies the consumer.

The invention employs a new payment medium that includes a system of unique primary barcodes which are personal to a customer and may be tendered at the POS of a merchant or retailer. The primary barcode may be an International Standards Organization barcode, a Global Electronic Party Information Registry barcode, a UPC barcode, or any other type of barcode. There is no requirement that the barcode be any particular type as long as the primary barcode may be read or entered by a barcode reader at a merchant's POS. In a preferred embodiment, so-called two-dimensional barcodes, or 2-D barcodes, are able to incorporate information sufficient to identify the parties to a transaction and all other relevant information regarding the transaction such that a transaction may be completed upon presentation and reading of the barcodes in a “single pass,” along with an identification of items that are the subject of a transaction.

Each customer-specific primary barcode is further linked to an extension barcode or barcodes. The extension barcodes are linked to specific retailers' POS systems and may also be linked to the retailers' inventory or SKU systems.

In a preferred embodiment of the invention, primary and extension barcode data may be combined into a single “combined” barcode for scanning. Such combined barcode may be presented to a POS system, a computer or any device capable of reading a barcode. The combined barcode contains all of the data required to authenticate, authorize, clear and settle a transaction.

Smart devices having internet connectivity may run an installed eCache application that, inter alia, combines the primary and extension barcode data, generates a combined barcode that may be encrypted, if desired, and that may be scanned in a single scan. The combined barcode may thereafter be decrypted and decomposed into the original primary and extension barcodes at the eCache server. In some embodiments, the application may also permit the primary barcode holder to create an extension barcode using an application that is downloaded to a smart device, smart phone, or computer. In this embodiment, the primary barcode holder is given the ability to create complete transactions. In cases in which the POS does not have a scanner, any barcode may be entered manually into a device capable of capturing and processing the information. In addition, the application may take advantage of a smart device's global location services to facilitate communications with eCache or any other external source to authenticate, authorize, clear, and settle a transaction, or to determine the location of the user and the identity of the merchant situated at the user's location.

Smart devices may be used to receive barcodes generated by the eCache server or, alternatively, to generate barcodes from information previously downloaded from the eCache server. As used herein, “smart phone” refers to existing internet-accessible smart devices capable of running installed applications, and those to be developed in the future, regardless whether they perform traditional telephonic activities or of the wireless protocol or medium through which they access the internet. One of the advantages of smart phone technology is the display capability which allows for the smart phone to receive and display various images in addition to data. Another advantage is the ability to encrypt or decrypt information sent between the smart phone and the proprietary network. Smart phones also allow a customer or other user to download and install software applications onto the phone. These software applications can take the form of games, GPS tracking, software, financial services management or in the case of this invention the eCache software application. The eCache application is downloaded after the customer or other user enrolls with eCache. Since the customer or user will have downloaded and installed the eCache application, the invention is not dependent upon the cellular provider to provide any service other than internet connectivity for the transmission of data.

The customer may enroll and supply information sufficient to verify the customer's identity. The customer also enters specific information that creates a personal value profile. The value profile contains information such as DDA (direct deposit account) account numbers, credit and debit stored value card account numbers, reward program information, acceptance of promotional offers from selected merchants, and the customer's preference to receive coupons. The value profile might also contain an optional application for overdraft loans or consumer loans as a source of settlement funds. The credit facility could be offered by eCache, the merchant or an alliance partner. The value profile also asks the customer to select settlement preferences. For example, a customer might do weekly grocery shopping at a particular grocer. The grocer might have a loyalty program that offers members special weekly promotional offers, or might have coupons that the grocer wishes to offer to the customer. Additionally, the merchant—in this example, a grocer—might have entered into an agreement with a rewards point issuer, such as an airline or credit card issuer, to allow customers to redeem reward points to be applied to purchase merchandise in the merchant's stores. The value or conversion rate from reward points to the merchant might vary, so the invention manages the conversion from reward value to merchant dollars. In this manner the customer can establish a preference with a grocer to “pay” or settle a transaction in the following manner: First, apply any promotional dollars; second, apply coupons; third, convert points from the customer's airline card; and, fourth, the remainder of the cost of the transaction is to be deducted from the customer's DDA account. This list and sequence is illustrative only. In this embodiment, the customer or user is capable of controlling the settlement. In the process, the customer is able to control the value of the reward points being used. The customer's value creates controls for settlement options.

Alternatively, the merchant or provider of goods or services may control the value of the transaction by reducing interchange fees and creating promotions for the merchant's customers. For example the merchant may create promotional offers to stimulate the sales of “house” brands that have a higher profit margin for the merchant, or may influence the customer to pay or settle from the customer's DDA account instead of using credit or debit cards which have high acceptance costs due to “interchange” fees imposed by card associations, by for example associating rewards points with transactions that utilize a DDA. The merchant might also want to move merchandise at a particular store location. For example, if a store had an oversupply of a perishable good or an item that will soon be out of date, the merchant may wish to push a special coupon to a customer who has the eCache application on the customer's cell phone. The GPS tracking component of a smart phone allows the merchant to know that a customer has entered a specific store. Store specific coupons or offers can then be sent to the eCache application to be included in the customer's settlement profile. Alternatively, the merchant has a GPS coordinate for each POS scanner connected to the network. When a transaction is scanned from a specific scanner the merchant and eCache know the location of the customer and may send time sensitive coupons to the customer's smart device for use with local merchants in close proximity to the customer. Such coupons may be sent during or immediately following checkout, and will offer bargains or discounts to the customer if used prior to their expiration time in a store of another merchant located near the customer's location.

Each primary barcode is personal to a customer and may take many different forms. Primary barcodes are issued to qualified customers and allow for the ready payment of commercial transactions and further allow for the gathering of a wide variety of information related to the transaction. Qualified customers will have agreed to terms and conditions for use of the barcode system and may have submitted a wide variety of information in connection therewith. The information may include full name, address, telephone number, driver's license information, e-mail address or other identifying and demographic data. Such information may further include demand deposit account (“DDA”) information, and account information concerning credit cards, debit cards, stored value or prepaid cards or payment methods. Customers using the eCache system will conclude and fund transactions by initiating an ACH transaction or a general purpose card transaction using one of the accounts.

In addition to the primary barcode, each customer is also provided with an extension barcode or barcodes which may either be assigned to the customer or selected by the customer. The extension barcodes are linked to a specific retailer and allow a customer the privilege of completing a sales transaction with that retailer who is a participant in the barcode program. For purposes of security against barcode theft or fraud, an individual's master barcode may not be given to the individual, but may be maintained by the eCache system and linked to one or more primary barcodes issued to the individual for day in and day out usage. In some embodiments, the master and extension barcodes may be combined into a single encrypted barcode to be used by the smart phone application. In one preferred embodiment, barcodes will be issued on a one-time, single-transaction use, and will be discarded when the purpose of identifying the customer, customer preferences, or other data associated with the transaction has been completed. The extension barcode may be a scanable barcode or may take the form of a series of numbers or characters that may be entered by key pad or other mechanism.

Of relevance to the instant invention, a smart phone can receive or generate, and can display 2-D barcodes. 2-D barcodes are images that can be recognized by various optical scanning technologies. 2-D barcodes enjoy significant advantages over existing technology in that significant amounts of data, up to a terabyte, may be encoded in a 2-D barcode. The 2-D barcode becomes the intersection between the 2-Dbarcode “view” presented by the customer and “sku”s associated with the merchant's inventory the customer wishes to purchase. The 2-D barcode can also be scanned from any medium that can project a 2-D barcode for viewing. For example, the barcode could be scanned or viewed from an LCD on a watch, a computer monitor, a TV screen, a piece of paper or plastic, or any other medium capable of producing a 2-D barcode symbology view that can be scanned. The scanned 2-D barcode becomes a single pass authorization and settlement device. However, this invention is not limited to 2-D barcodes, as the invention is fully operable with any scanable image capable of containing data that can be received and viewed on an internet accessible device.

When a customer wishes to purchase items using the eCache system, the customer will open his or her eCache application on his or her smart phone by touching the eCache icon on the phone when making a transaction. The eCache application cannot be opened without the successful entry of a preselected personal alphanumeric code (“PAN” or “PIN”) that the customer has previously established in the customer's value profile. The eCache application on the smart phone may link to an external eCache server to prefetch customer data (such as a value profile) or may use information contained within the eCache application on the smart phone to generate a transaction specific 2-D barcode that may contain a security “token” that the customer then presents at a point of sale. The 2-D barcode has encoded detailed information concerning the transaction which may include designating particular accounts through which a transaction may be settled and allocating rewards points to be used in connection with settling the transaction. The 2-D barcode may further reflect in-store coupons or other promotions that may also be part of the settlement of the transaction.

The customer will present items to be purchased to the cashier who scans the items as with any other typical purchase. The customer then tenders his or her primary and extension barcodes via a smart phone to the cashier, other POS personnel for scanning; or could, in the absence of a scanner, input the barcodes himself or herself, as in the case of a self-serve checkout lane. The merchant's POS system will then transmit the barcodes to the eCache server which will validate them.

Once the barcodes have been validated, the merchant's POS personnel enter the purchase items as they would ordinarily. When the total sales are “rung up,” the totals, now associated with the merchant identified by the extension barcode, are routed to the eCache server for either an approval or decline of the sales transaction.

In one embodiment, the merchant's POS scanner becomes the “single pass” authorization and settlement device by matching the merchant's transaction ticket data with the customer's value profile. Prior to scanning, the smart phone will either generate a barcode based upon information stored in the eCache mobile application, or will download a barcode generated and assigned by the eCache server. In the latter case, security tokens and payment tokens may be exchanged in order that the barcode and other data associated with the transaction may be encrypted before sending, thereby reducing or eliminating the likelihood of the system being used by unauthorized persons. In other embodiments, where a transaction may be of low value or, where the risk of fraud is deemed to be low, a transaction may be made using any device capable of capturing the customer's PIN without creating an extension barcode. Similarly, the mobile application may be able to assess the value or risk of fraud in a transaction, or may access the eCache server for such information, where the parties wish to complete a transaction using only a single, primary barcode.

The approval process may include the use of databases that contain negative and positive transaction data related to the customer who has presented the barcode for validation. Such other information may be of significance to a retailer, such as an “excessive returns” database. For instance, if the customer had previously presented a barcode in connection with a sale that has previously been approved but which was subsequently denied before being funded, the transaction would be posted to a negative database, and would remain associated with that customer. Thus when the same customer presented the barcodes for a later sales transaction, the merchant would have access to the associated negative history. Positive transactions associated with a customer through the bar code system would likewise be recorded and available for the merchant's information, or to other merchants in the eCache network. Transactions could also be approved or declined after reviewing a merchant return database. A history of excessive returns may result in a declined transaction.

If the purchase is approved, then settlement of the purchase may proceed as an ordinary ACH settlement, or a credit settlement, or by any other suitable method. Settlement of an eCache server transaction occurs when available funds are transferred in consideration of an obligation and the transfer has been recorded in each party's account, which may be a bank account (DDA).

The eCache application on the customer's smart phone also has an optional virtual ATM application. The virtual ATM allows the customer to create a specific instant value profile that identifies various accounts from which the customer may choose to transfer funds and monitor and/or exchange reward points from customer loyalty programs. The virtual ATM allows the customer to select the eCache account from an icon and to use that account in executing a purchase. Additionally the customer can choose to have a request for cash added to the final transaction amount. The virtual ATM allows a customer to manage his or her eCache DDA and monitor or convert various loyalty or rewards points that customers earn by shopping at particular stores or using particular accounts to clear a given transaction. Another embodiment of the virtual ATM is the use of a line of credit, a payday loan, micro loan or any type of consumer loan as a method to load value for merchant's transaction settlement with eCache. In one embodiment of the invention, an eCache customer may select the ATM function and instructs the ATM to issue “cash back” of $100.00. This “cash back” is drawn against a credit line linked back to an alliance partner of eCache that accepts the credit risk of the transaction and refunds the cash advance to the merchant overnight, accepting the liability of collecting the cash draw from the customer on terms and conditions accepted in a pre-registration phase with that customer authorizing a credit facility. In effect, the POS cash drawer becomes the ATM disbursement method. The withdrawal bypasses traditional payment networks such as ATM networks, card networks, EFT networks and does not tie back to the customer's DDA. Rather it is a draw against any type of consumer loan held by the customer, eCache, or an alliance partner.

In making a purchase at a store, a customer would select the eCache icon through the virtual ATM, or from a different link. The customer would then enter a personal alphanumeric code (PAN). The customer may have previously established a value profile to be used at a particular store that gives greater reward points for a transaction that does not involve a debit or credit card for settlement. In this example, the customer could specify that a specific DDA account would be used to settle the transaction. In this manner, the customer would be able to control how each transaction would clear or settle. The eCache system may also be configured to maintain track of and to allocate a given merchant's loyalty program points for use in a particular purchase. Thus a customer can also preset a preference for the use of any earned loyalty points for a purchase.

Another function of the system allows for a subsequent confirmation by routing the requested transactions through an external verification service. Such service may include, without limitation, check guarantee services, credit bureaus, or credit, signature debit or PIN debit authorization services for a further approval or decline. Thus, whether eCache issues an approval or a decline, the system allows for further validation of the transaction if the merchant so desires. Contingent upon the result of that process, the merchant can determine whether to proceed and complete the transaction or to decline it. As stated above, depending on the result of that process, the customer's purchase can be settled using an ACH route, or credit route, or any other acceptable means to fund the transaction.

Another aspect of the invention involves the administration of buyer reward and buyer loyalty programs. Under a typical reward or loyalty program, qualified customers “earn” future discounts, gifts, or even refunds, based on how often they shop at a particular retailer and the value of the customers' spending at that retailer. Under a usual system, the more a customer spends, the more he or she “earns” as a reward for their continued patronage. The difficulty arises, however, in compiling and maintaining a sufficient database of information to allow for the administration of the program. Cashiers or other POS personnel, for example, would have difficulty in recording and entering the sort of data needed to run such a program manually. The present invention, however, allows for the automatic compilation of sales transaction data by utilizing the link between the retailer's inventory system, the POS system, and the merchant's barcode readers coupled with the customer's extension barcode. Thus purchases by qualified customers are tracked and maintained by the system and can be used to administer and manage buyer rewards or loyalty programs.

As a concomitant to establishing a buyer reward or loyalty program, the present system allows a merchant a simple and practical method of ensuring that such programs are properly funded. Depending on the design of the program by the merchant, the eCache system is capable of earmarking a predetermined percentage or fixed amount of any sales transaction for the purpose of funding a pooled reward account. Thus the merchant is in a position to ensure that there are adequate resources to fund the rewards program.

The eCache system further facilitates consignment relationships between suppliers and merchants. In a typical consignment transaction, the merchant agrees to carry a stock of merchandise for the buyer but has not yet purchased the item from the supplier. If the item is sold, the merchant remunerates the supplier for the item while retaining a portion as profit or fee. Such commercial relations are time consuming and difficult to administer as adequate records of the sale must be maintained to ensure both retailer and supplier are properly compensated. There are often further delays associated with the final settling of accounts between the merchant and supplier. For example, the merchant may wish to ensure the customer's transaction is finally settled before settling with the supplier. By residing within the merchant's POS and inventory system, eCache allows consignment items to be recognized and, under appropriate circumstances based on criteria of the merchant, to be settled quickly with both customer and supplier.

It is thus an object of this invention to utilize existing systems and networks including POS systems, retailer inventory system, SKU systems and ACH networks to link customer transaction data to individual customers so that such information may be used to evaluate whether to allow a purchase to conclude.

It is a further object of this invention to utilize existing host networks already in place in the form of the internet and the wired and wireless phone networks, including all the support hardware and software that currently exists and is embodied as computers, cell phones and telephones, to supplement a proprietary extranet in performing the functions of transaction authorization, authentication, and settlement with immediacy and within a secure environment.

It is further an object of this invention to provide an alternative medium of exchange without the excessive interchange fees that accompany typical credit and debit transactions.

It is a further object of this invention to adapt the characteristics of a physical world ATM through a proprietary extranet having a virtual device for transposing a user's bank funds into animated cash-like authentication tokens that reside inside the extranet to settle commercial remittance transactions.

It is another object of the invention to adapt a physical world ATM through the eCache server as a virtual device to transport bank funds into a virtual demand deposit account that resides within the eCache system where authentication tokens can be decomposed into electronic wire-like transfers to user's virtual demand deposit account.

It is yet another object of this invention to integrate the authenticator and processor functions of the debit-like device using the eCache network with a virtual enterprise network to provide the user with the immediacy, security and finality similar to a physical world debit transaction but without reference to bank routing number or the user's personal account number.

It is a further object of this invention to add a third layer of security to give the user the option to interface the notice of each commercial remittance with a smart phone through short message service (SMS) text messaging to validate the commercial remittance transaction before it is processed through the eCache server.

It is a further object of this invention to provide a system for gathering data, so-called “basket metrics” and linking such data to particular customers so that the merchant may use the information to more effectively market to and target customers.

It is another object of the present invention to provide a system in which a merchant can compile a database of customer information related to customer purchasing that can be modeled to more effectively target new customers or increase sales to existing customers.

It is another object of the instant invention to provide a system for gathering customer transaction related data for administering effective buyer reward and loyalty programs.

It is another object of this invention to allow for the effective tracking of customer purchasing information so that merchants may assemble profiles of customers for determining which customers are high value customers and which are not.

It is a further object of the instant invention to allow a system whereby a merchant may designate portions of each customer transaction for funding a pooled reward account through which buyer reward and loyalty programs may be funded.

It is a further object of this invention to provide a system that can facilitate traditional consignment relationships, including the timely remuneration of the parties thereto.

It is a further object of this invention to employ smart phones in conjunction with barcode technology to empower customers and merchants to manage and control the settlement of their transactions.

### BRIEF DESCRIPTION OF THE DRAWINGS

FIG. 1 depicts connections between an eCache server and other networks.

FIG. 1A depicts another embodiment of connections between an eCache server and other networks.

FIG. 2 depicts links between a master barcode, a primary barcode, and a number of extension barcodes.

FIG. 3 depicts a flow chart showing validation of customer using the system of this invention.

FIG. 4 depicts another embodiment of the validation and approval process.

FIG. 5 depicts another embodiment in which additional information is used to make a decision whether to approve or decline a transaction.

FIG. 6 depicts an embodiment in which a rewards program is incorporated into the system of this invention.

FIG. 7A depicts an embodiment for consignment transactions.

FIG. 7B depicts an embodiment for purchases of consigned items.

FIG. 8 depicts an overview of the primary components of the system of the invention.

FIG. 9 depicts a flow chart showing the steps to initialize the mobile application.

FIG. 10 depicts a display of the eCache icon.

FIG. 11 depicts a display of a PIN entry screen.

FIG. 12 depicts a display of a handset pairing screen.

FIG. 13 depicts a display of a PIN selection screen.

FIG. 14 depicts another embodiment of a display of a PIN entry screen.

FIG. 15 depicts a display of a transaction selection screen.

FIG. 16 depicts a display of a merchant selection screen.

FIG. 17 depicts a display of a scanable 2-D barcode on a screen.

FIG. 18 depicts a display of a completed transaction screen.

FIG. 19 depicts another embodiment of a completed transaction screen.

FIG. 20 depicts a display of a cash back selection screen.

FIG. 21 depicts a display of a purchase approval screen.

FIG. 22 depicts another embodiment of a completed transaction screen.

FIG. 23 depicts a display of a transaction cancelled screen.

### DETAILED DESCRIPTION OF THE PREFERRED EMBODIMENTS

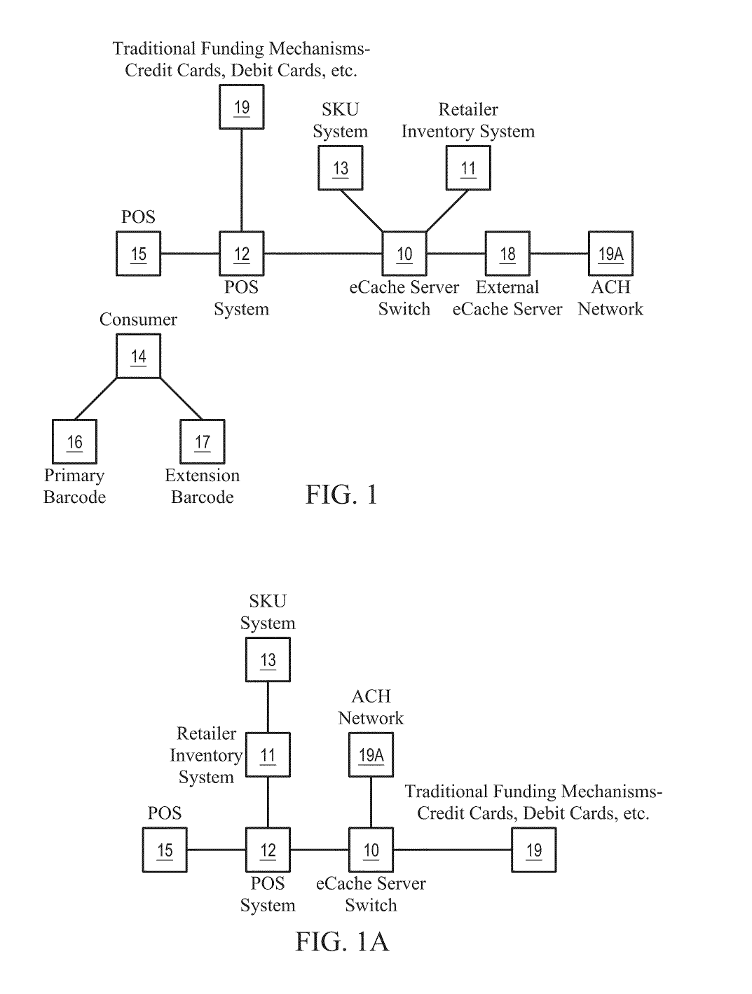

FIG. 1 depicts one embodiment of the invention. Here the eCache server, 10, is linked to the retailer's inventory system, 11, and to the retailer's POS system, 12 and to the retailers' SKU system, 13. Depending on the connectivity of the retailer's systems and network, the eCache server, 10, may be directly linked to only one node, or as here, by way of example, to multiple nodes. The eCache server may be linked to an external eCache server or servers. A further link, 18, between the eCache server and the ACH network, 19A, allows for transactions to proceed as ACH transactions. Because eCache does not displace and preclude the use of other payment systems, there will typically be a further link, 19, that allows payments to proceed via traditional methods such as credit cards, debit cards or similar devices. A transaction according to the present invention may include a customer, 14, who after presenting items to the cashier for scanning or totaling, presents his or her primary barcode, 16, at the retailers POS reader or input keyboard, 15. The primary barcode, 16, has been assigned to the customer. An extension barcode, 17, is also assigned or may be selected by the customer. The individual customer's primary barcode, 16, and each extension barcode, 17, are linked to a customer in the eCache system.

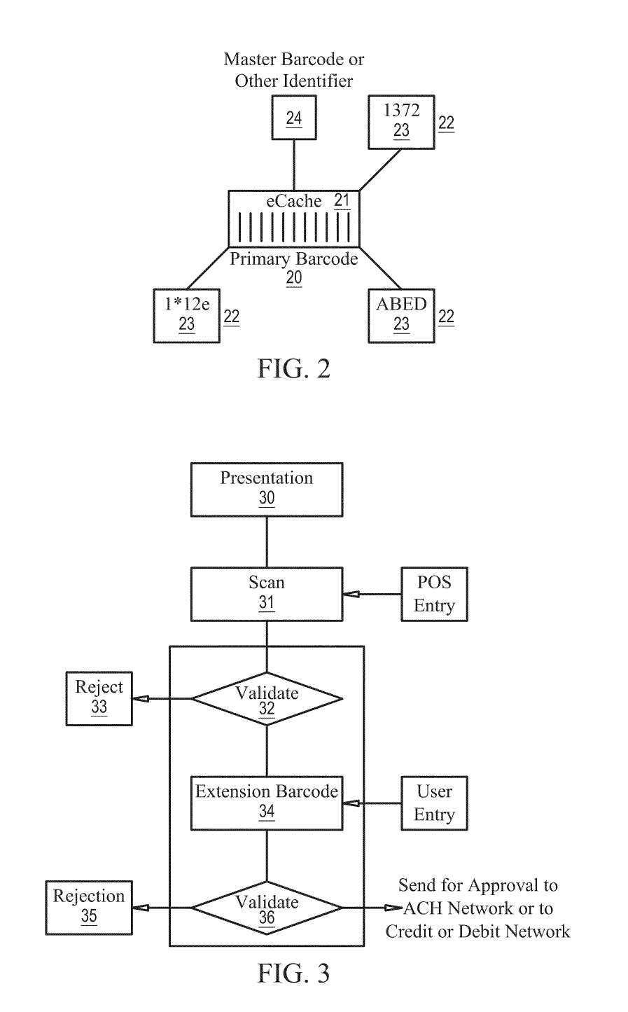

FIG. 2 depicts the linkage. In FIG. 2, a barcode, 20, may be affixed to any medium such as an identification card, a credit card or even a personal item such as an article of jewelry. It may further be marked with an eCache logo, 21, or other signifier showing that the barcode is linked to the eCache network. In a preferred embodiment, it will be displayed on a smart phone. The customer's primary barcode is cross referenced to various retailer-specific extension barcode barcodes, 22, that have been selected by or assigned to the customer. FIG. 2, also depicts a primary barcode and multiple retailers to which it can be linked via the extension barcodes, 22. In some embodiments, the primary and extension barcodes may be merged into a single, unified barcode that contains all of the information included in the primary and extension barcodes. The single barcode may be displayed on a smart phone for scanning, and may be used a single time before being discarded.

FIG. 1A shows another embodiment of the system. Here the merchant's computer network environment exhibits a high degree of connectivity. In this embodiment, the merchant's retailer inventory system, SKU system and POS system are all interconnected. The eCache system may therefore operate by connecting the eCache server to any node on the system, for example, to the POS system which is itself further linked to the merchant's SKU and inventory systems. In this embodiment, the ACH network as well as traditional payment mechanisms are accessed through the eCache server.

In yet another embodiment of the instant invention, all traditional funding mechanism transactions are routed to an external eCache server. eCache would then aggregate such transactions from multiple retailers to submit to a traditional funding processor to garner lower volume pricing for these transactions than what retailers might have been able to negotiate on their own.

FIG. 3 shows one embodiment the system in use. The customer presents his primary barcode, 30, to the cashier or merchant personnel. The cashier scans the primary barcode, 30, through a reader or otherwise enters, 31, the primary barcode, 30, into the POS system. The primary barcode information is transmitted over the network via a communications link to the eCache server for validation and confirmation that the user is authorized to use eCache, 32. If the barcode is not recognized, or if the account is otherwise barred, the system issues a rejection, 33. If the primary barcode, has been validated, eCache sends a further prompt, 34, requiring the customer to input the extension barcode, 36. eCache may decline to approve the extension barcode depending on various criteria and issue a rejection, 35. If eCache further approves the extension barcode, 36, the customer is allowed to continue the purchase via eCache. eCache will then send the requested transaction for an approval or decline of payment. Additionally, the merchant's POS system may itself prompt for the extension barcode. Alternatively, the primary barcode may be transmitted via the eCache server to an external eCache server or bank of servers from which the extension barcode prompt is then generated.

In practice, a customer may be issued as many extension barcodes as or he or she wishes one for each of the various participating merchants. If the customer makes purchases at more than one retailer, he or she will have an extension barcode for each location. Thus the customer's primary barcode, 20, may be linked to numerous extension barcodes, 22, each one being specific to a given retailer. FIG. 2 depicts this linking of primary barcode, 20, to extension barcodes, 22. In some embodiments, the customer may select from which account he or she will fund the transaction by varying the last digit 23 of the extension barcode. The customer can therefore direct that the transaction be completed from his or her checking account, debit card account, demand deposit account, or other suitable source.

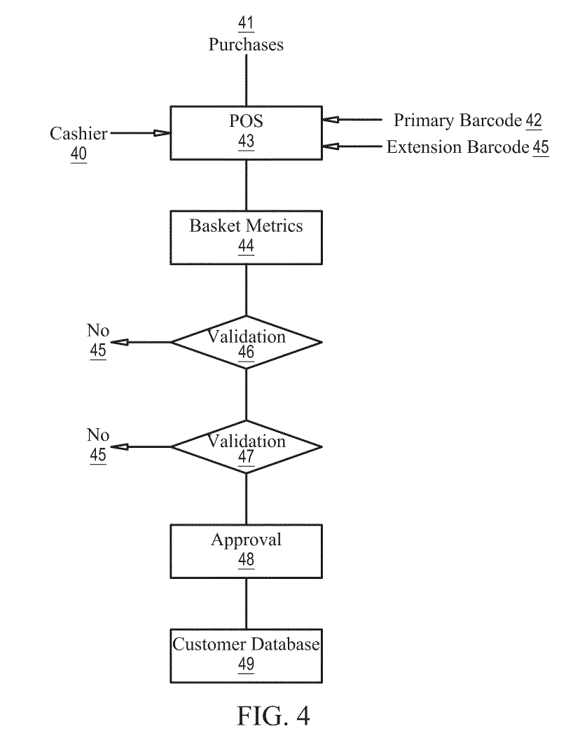

In a typical transaction, FIG. 4, once the cashier or other sales person, 40, processes a customer's purchases, 41, the customer will tender his or her barcode, 42, to the cashier for input into the barcode reader at the POS, 43 and for validation as described herein. In one aspect of the present invention, the POS system has recorded various “basket metrics”, 44, associated with the customer's attempted purchases, 41. As outlined above, eCache may issue a rejection, 45, terminating the transaction as an eCache transaction. Assuming validation occurs, however, upon validation of the primary barcode, 42, validation of the extension barcode, 43, and approval, 48, the customer's purchases, 41, are associated with the customer and stored in a database, 49. Thus, as the customer's purchases, 41, are entered into the retailer's POS system, the eCache system via a communications link to the eCache server, 47, records such data as item quantity, price, total amount, store location, use of coupons or other promotion codes, and other data that may reflect pertinent transaction-related data concerning the exchange. Some retailers, as an alternative, might compile the purchase metrics and transfer the information to eCache at a later time. The transaction data is associated with the customer's primary barcode or extension barcode in a transaction database, 49, so that the merchant will have access to the information. The merchant will therefore be able to assemble a profile and history of the customer as transactions are completed and stored by the system. The resultant transaction data may then be used by the merchant in formatting marketing strategies or for other similar purposes. Given the growth of data mining techniques, the transaction data may also be exchanged with various companies that use such data. Thus, the system of this invention allows the merchant to realize a strategic asset from the costs of executing a transaction whereas, without the invention, transaction costs will typically go unrecovered by the merchant.

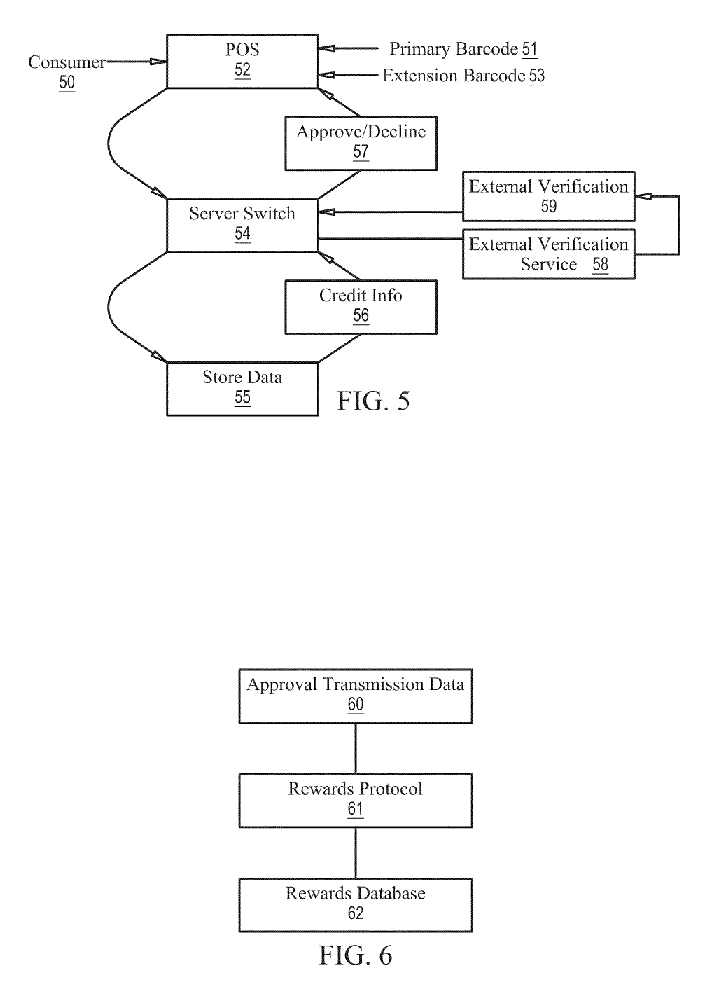

The present invention incorporates additional functionality as well, and allows the merchant to track and access credit information of the customers who use the system. This is depicted in FIG. 5. Thus in one aspect of the present invention, a customer, 50, presents his or her primary barcode, 51, for validation at a retailer's POS, 52. Upon being prompted, the customer enters his or her extension barcode, 53. Upon validation of the extension barcode, the eCache system, through the eCache server, 54, accesses stored data, 55, related to the history of the customer's transactions. eCache can then issue an approval or decline based on criteria formulated by the merchant or other entity and stored on the eCache server or external eCache servers. The approval or decline is then transmitted to the merchant at the POS, 52. The criteria may be entered into the system by eCache personnel. Additionally, in other embodiments, the merchant itself may enter the approval or decline criteria.

The decision to accept or decline the transaction may be made based solely upon the information stored in the database from a specific retailer, or it might be a compilation of transactions with all eCache merchants. Further, the database may be updated periodically on, for example, an hourly basis. In FIG. 5, the customer, 50, has presented the primary and extension barcodes for validation at the retailer's POS, 52. As shown, eCache now accesses stored data based on prior transactions or attempted transactions, 55. In this example the customer has previously completed a purchase, for example, from a credit card account, which subsequently was declined. Ordinarily, a merchant would not have access to this information but the eCache system accesses the stored credit transaction data, here negative data, which has been stored in a database, 55 and that has been associated with the customer, 50. Based on eCache's evaluation of the negative data, 56, a decision may be made and eCache can approve or decline the transaction, 57.

Alternatively, through another communications link, 58, eCache may connect to an external verification service, 56, such as check guarantee services, or credit bureau or credit, signature debit or PIN debit authorization services, for a further approval or decline. Depending on the results of that verification, 59, eCache can formulate a decision to allow or decline the transaction.

Similarly, eCache allows for previously stored positive transaction data to be used by the merchant in formulating an approval or decline or for other purposes including targeting specific marketing material to profitable customers. Such information, like negative information, may be shared with other eCache merchants. In that case, the information is drawn from stored databases of positive and negative transaction- related data, including, excessive return information, and can be used by all eCache merchants to determine whether and on what terms a transaction can be approved. It should be appreciated that these decision-related functions may take place within the merchant's own system. Alternatively, the relevant data may be transmitted to an eCache server or server bank where the data may also be stored and where approvals or declines may also be formulated.

eCache also allows decisions whether to close a transaction to be based on other criteria. As an example, a customer may have had an excessive history of returns, i.e., the return of merchandise previously purchased for a refund. eCache allows the merchant to track returns by customer. This information is entered into a database as stored data detailing excessive returns. When the eCache barcode is presented at the POS, eCache can access the stored data to determine whether the customer has had a history of excessive returns and, depending on merchant established criteria, can issue an approval or decline.

Another aspect of the present invention allows the merchant to track purchases and sales for purposes of administering buyer loyalty and rewards programs. Thus in one embodiment of the current invention, eCache will track an individual customer's purchases by amount, type and quantity for the purposes of determining eligibility for participation in such programs as might be established by the merchant. FIG. 6 depicts a rewards program in operation. Where a retailer has established such a program, the retailer will establish a schedule or rules, 61, concerning eligibility for rewards and the administration of such a program. Rewards may include, for example, discounts, merchandise or even cash back to frequent or high volume purchasers. Typically, a customer's eligibility to participate will depend on the value of purchases or frequency of purchases that he or she has made. Thus upon presentation by a customer of the primary barcode and extension barcode at the merchant's POS, eCache, upon receipt of the extension barcode will compile and record the transaction data which is applied to the schedule or rules, 61. The results of that process are associated with the customer through the extension barcode and primary barcode for purposes of administering the reward program and stored in the rewards database. Subsequently, eCache can access such stored data as to volume or value of previous purchases by a customer from the retailer to determine whether and to what extent a customer qualifies for any perquisites as a participant in a rewards program.

The eCache system further allows a merchant to ensure that any programs he or she may establish are adequately funded from the customer's purchases. The system thus allows the merchant to designate that a portion of any sales transaction be used for purposes of funding a pooled reward account that is in turn used to fund the reward or loyalty program.

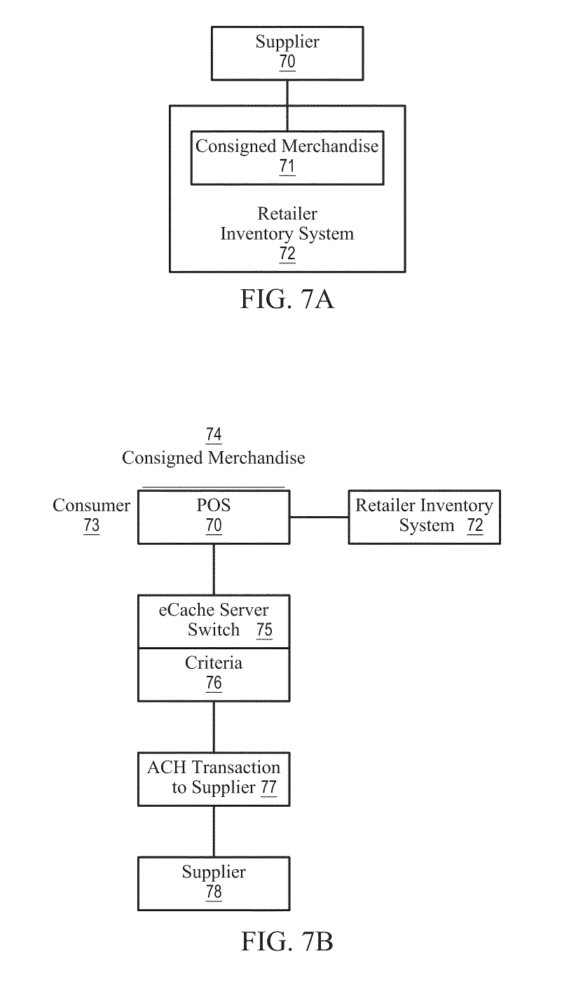

Another embodiment of the present invention illustrates its use in managing effective consignment relationships. FIG. 7a depicts a typical consignment transaction using the eCache system. Here, the supplier, 70, has consigned merchandise, 71, for sale at the retailer location. The consigned merchandise, 71, has been designated as such in the merchant's inventory system, 72.

In FIG. 7b, a customer, 73, who wishes to purchase the consigned merchandise, 74, will present the items for entry at the POS, 70. The cashier will scan the consignment items and the customer will tender the eCache barcode and extension barcodes for payment. The POS communicates with the retail inventory system, 72, and determines that the merchandise has been consigned by a supplier. The retailer POS system then transmits this information to the eCache server, 75. The merchandise is recognized as consigned merchandise and, according to predetermined criteria, 76, previously entered by the merchant, eCache assigns a percentage or portion of the price to be remitted via an ACH transaction, 77, to the supplier, 78 in settlement of the relationship. eCache allows great flexibility to a merchant to determine the terms and details of any consignment relationship including the time of remittance of payment to the supplier, depending on the specific profile of a given customer.

In one embodiment of the invention, once the customer enters his PIN, the eCache system will generate a unique 2-D barcode that encodes all such preferences and instructions. The 2-D barcode is presented to the cashier by the customer, who scans the barcode into the merchant's system. The system is capable of translating the information and instructions encoded in the 2-D barcode and completing the transaction along the preset or selected parameters. Thus the 2-D barcode might include an express authorization to clear the transaction through an associated credit card network after applying the customer's reward points to discount the sales amount. The system thus allows for a “single scan” checkout where coupons, loyalty points and payment routing are all dictated by the transaction specific 2-D barcode. For example, whereas in a typical checkout, a coupon is separately scanned, in this embodiment of the invention all such promotional items are built into the 2-D barcode. This dramatically reduces the need for complex networking because the 2-D barcode already includes a comprehensive set of transaction instructions.

The system is not, however, just limited to customer's preferences. Merchants themselves may also establish a profile and incorporate preferences. For example, a multiplicity of factors comes into play when a purchase transaction settles. These include direct costs to the merchant, clearance times and potential risks of default. Where a customer has expressed no preference for possible clearance routes, the merchant can indicate preferences of its own that could be used to advantageously clear a transaction through the least expensive or fastest route. The system can also be configured to, for example, decline to clear an “ACH” transaction presented by a customer where a previous ACH transaction had been declined or returned.

The prevalent use of smart phones capable of running installed applications permits smart phone devices to be used in this invention to initiate and complete financial and non-financial transactions. In a preferred embodiment, the customer will be required to enroll and supply information sufficient to verify the customer's identity. At the time of registration, the eCache enrollment system will generate a valid pairing code which is a key to bond a smart phone to an eCache account. The pairing code, when entered and accepted, then forwards the smart phone's Serial Number, IMEI, and ICCID to the eCache master system.

At registration, the customer also creates a PIN that may be of fixed or variable length. The customer also enters specific information that creates a personal value profile. The value profile contains information such as DDA (direct deposit account) account numbers, credit and debit stored value card account numbers, reward program information, acceptance of promotional offers from selected merchants, and the customer's preference to receive coupons. The value profile might also contain an optional application for overdraft loans or consumer loans as a source of settlement funds. The credit facility could be offered by eCache, the merchant, or an alliance partner. The value profile also asks the customer to select settlement preferences.

Smart phones are particularly well-suited to receive or generate and display so-called 2-D barcodes. 2-D barcodes are images that can be recognized by various optical scanning technologies, as shown in FIG. 17. 2-D barcodes enjoy significant advantages over existing technology in that significant amounts of data may be encoded in a 2-D barcode. The 2-D barcode becomes the intersection between the 2-D barcode “view” presented by the customer and “sku”s associated with the merchant's inventory the customer wishes to purchase. The 2-D barcode can also be scanned from any medium that can project a 2-D barcode for viewing. In addition to showing the barcode on a smart phone display, the barcode could also be scanned or viewed from an LCD on a watch, a computer monitor, a TV screen, a piece of paper or plastic, or any other medium capable of producing a 2-D barcode symbology view that can be scanned. The scanned 2-D barcode becomes a single pass authorization and settlement device.

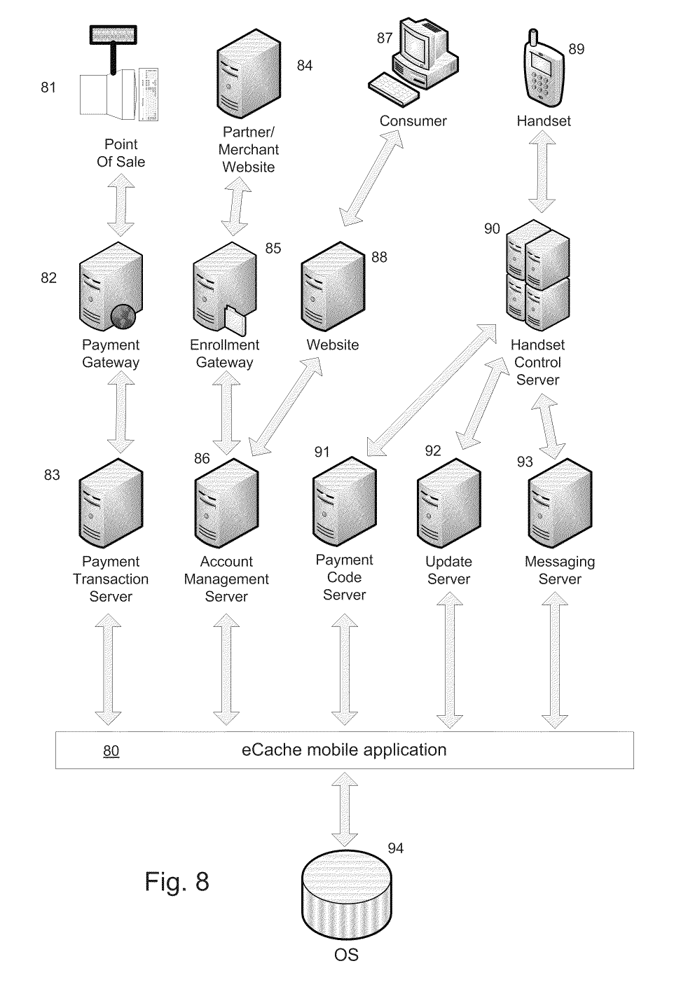

An overview of a preferred embodiment of the system of the invention is shown in FIG. 8. In FIG. 8, the eCache mobile application 80 is shown as communicating with an operating system 94, from which instructions and program flow is controlled. To initiate the process of using a smart phone to conduct transactions in accordance with the system of this invention, merchants 84 wishing to use the system enroll on an enrollment gateway 85 which then passes the merchant data to the account management server 86. Customers 87 enrolling in the system much register on website 88 from which the customer's information will be passed to account management server 86, where the customer's value profile will be created. In an embodiment, the information may include the customer's selection of a PIN, an identification of the smart phone to be registered, and other information regarding the customer and customer preferences. At enrollment, the customer is issued a pairing code which will be used when the application is run from the smart phone handset 89. When the handset launches the application, the eCache system will recognize the entry of the pairing code on the handset, and will create a pairing of that handset to the user's value profile.

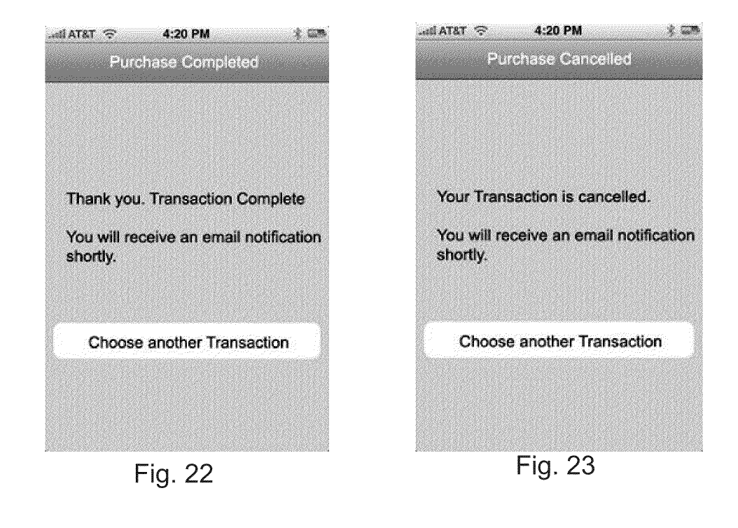

When the user wishes to commence a transaction, the smart phone 89 will first request the user's PIN and, if correctly given, will allow the application 80 to launch. Upon launch, the smart phone 89 will access the handset control server 90, and will receive any messages from the messaging server 93, updates from the update server 92, and payment tokens from the payment code server 91. Upon making desired selections among vendors and funding sources, user's handset will be sent encrypted data in a 2-D barcode. Thereafter, the user will take items to be purchased to the POS terminal 81, and will present the barcode displayed on the smart phone handset 89 for scanning. The POS terminal 81 will present the barcode to the payment gateway 82 and thence to the payment transaction server 83 where the barcode will be decrypted and transaction information processed. If the transaction is approved, a message indicating such approval, as in FIGS. 21 and 22, will be sent to the handset 89 via the messaging server 93, and the transaction will be settled. Conversely, if the transaction is not approved, it will be cancelled, as in FIG. 23.

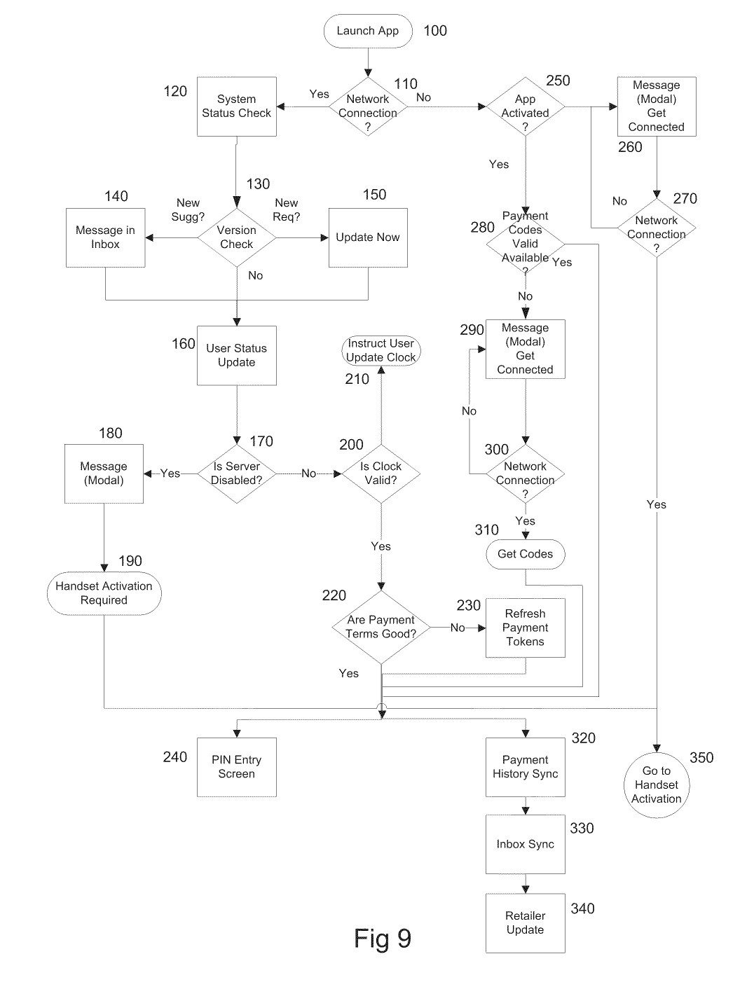

One process for implementing the invention on a smart phone is depicted in FIG. 9. FIG. 9 depicts the steps the mobile application will perform before requesting that the user enter a PIN. When the application is launched 100 the application will first seek a network connection 110. If a network is found, then a system status check 120 is performed, including a check to ensure that a proper version is running 130. If a newer version is available but not required, the user will be presented with a message asking whether an update is desired 140. If an update is required, then it will be immediately performed 150. User status is then updated 160 and an inquiry is made to the network whether the server is available to the application 170. If the server is disabled, the user will be sent a message 180 that handset activation is required, and the application will terminate 190 until handset activation occurs 350. If the server is not disabled, the application will check to see whether the smart phone's clock is valid 200, and if it is not, will instruct the user to update the clock 210 and will terminate until that has been accomplished. If the clock corresponds to the server's clock, the application then checks to see whether payment tokens on the handset are good 220. If the tokens are invalid, out of date, or otherwise not acceptable, the payment tokens will be refreshed 230 from the server and the program will proceed to the PIN entry screen 240 or, the application may be updated by synchronizing payment history 320, synchronizing the inbox 330 and updating retailer information 340.

If the application is unable to detect a network connection 110, the program will proceed to determine whether the application has been activated 250. If the application has not been activated, the application will attempt to detect a network connection 270. If no connection is available, the user will be presented with a message 260 to connect to a network. If a connection is available, the program will connect to the network and attempt to activate the handset 350.

If the application has already been activated 250, the application will then check to see whether valid payment codes are available 280. If payment codes are available, the program will proceed to the PIN entry screen 240, or to synchronizing and updating payment history and retailer information 320, 330, 340. If payment codes are not available, the application will once again check for a network connection 300 and if it does not find one, will notify the user to connect to the network 290. Once a network connection is achieved 310, the application will access the network and download valid payment codes 310. From there, the user will be presented with a PIN entry screen 240, or payment history synchronization, inbox synchronization, and retailer information updates 320, 330, 340 will be executed.

When using a smart phone, the handset must be activated and “paired” with the eCache system before it can be used. Handset activation is a process designed to provide a high level of security while still allowing for an easy-to-use activation experience. In one embodiment, handset activation is a simple four-step process performed by the account owner using the smart phone, the smart phone's application store, an Account Management Website 88 and 89 in FIG. 8, and a Handset Control Server 90 which is accessed by the eCache mobile application 80. This embodiment combines a onetime use payment code with a hash-based message authentication code (HMAC) encoded in a 2-D barcode for use in closing a financial transaction.

Once a customer has created a user account on the Account Management Website, the handset must be activated and “paired” to the system. The handset activation process is designed to provide a high level of security while still allowing for an easy-to-use activation experience.

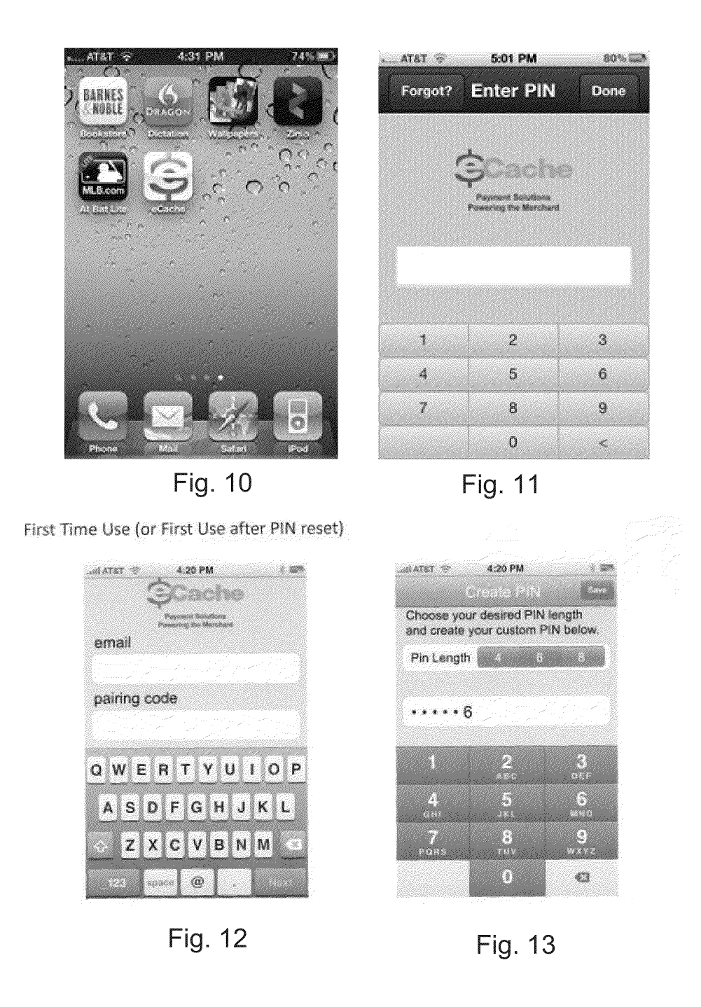

As is depicted in FIG. 10, an eCache mobile application is installed on the smart phone from an application store. Next, a paring code must be generated. In one embodiment, the user must log into the Account Management Website 88 using a computer 87 or other internet accessible device, and choose the option to create a new handset pairing. The website prompts the user to name the new handset (e.g., “Dad's iPhone”) and is presented with a code which may be of fixed or variable length to use as the handset pairing code for that handset. The user then launches the eCache mobile application 80 on the handset 89 and, as shown in FIG. 12, is presented with a dialog to activate the handset by providing the eCache username (or e-mail address) that was established when the account was opened. The user also enters the pairing code provided by the Account Management Website. This information is submitted to the Handset Control Server 90 for authorization and activation of the handset 89. Upon successful presentation of e-mail address and pairing code, the Handset Control Server passes to the handset the encryption key, pairing token, security token, configuration information, and initial payment codes required for making purchases. The handset is now paired.

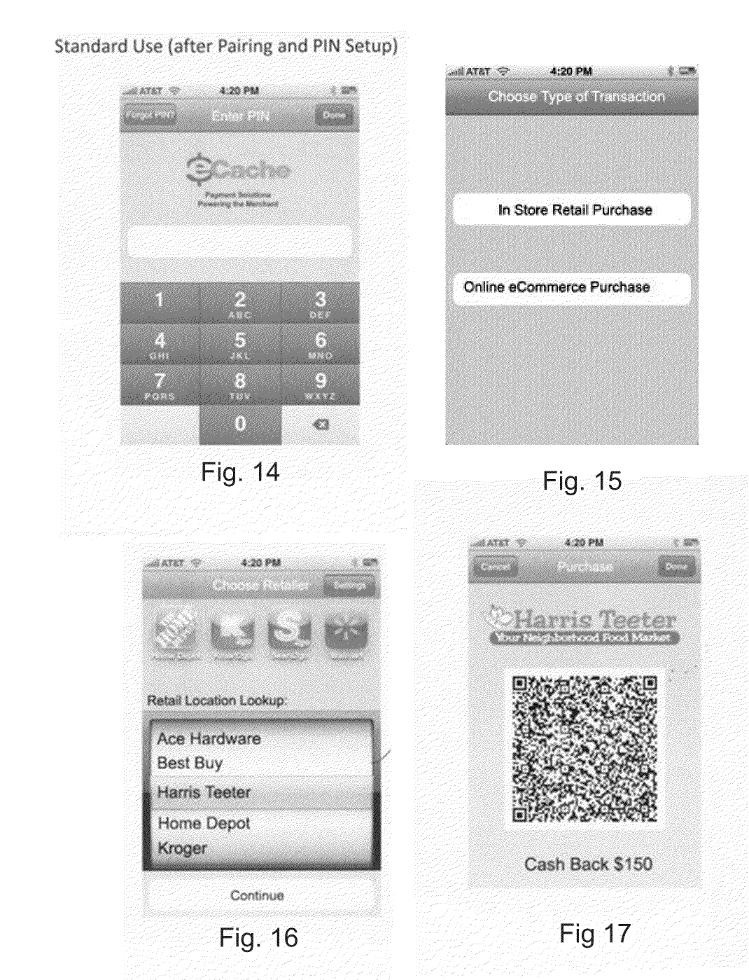

After pairing, the final step of handset activation is to set the screen access PIN. As depicted in FIG. 13, the screen access PIN is a fixed-length numeric security code whose length is chosen by the user, and that unlocks access to the user interface of the eCache mobile payment application on the handset. Once the screen access PIN is set, as depicted in FIG. 14, the handset is activated and available for use.

The handset activation process establishes a secure relationship between the downloaded smart phone application and the user's eCache account. The handset pairing process includes a series of account authorizations, and secure data exchanges. When requesting the creation of a new handset pairing when using the eCache system, information described below is created and associated with the pairing on the eCache Account Management Server 86.

A new paring token is generated, uniquely identifying this instance of the handset pairing. A new pairing code is used by the mobile application user each time a new transaction is initiated, and may be used to pair one handset to one eCache account one time. The pairing code and e-mail address are entered into an unpaired mobile application instance and securely sent via HTTPS to the Handset Control Server. The Handset Control Server 90 then presents this data to the Account Management Server 86 for validation. The pairing token is used to uniquely identify the origin of payment tokens which will be sent to the payment gateway during the transaction. The pairing token also indicates which encryption key associated with an eCache user will be used to securely validate the payment token. Once validated, the eCache Account Management Server 86 marks this pairing as active, invalidating the pairing code for future use.

A 1024-bit SHA-* compliant encryption key is created for use in generating all payment tokens associated with this handset's currently assigned pairing number. The encryption key is distributed to the handset and is used to securely generate the cryptographic security portion (the hash-based message authentication code) of the payment token.

The payment token is the data shared by the eCache mobile application 80 with the POS terminal 81 and is used by the POS terminal and shared with the Payment Gateway 82 to process a payment transaction. The payment token is encoded within a machine readable 2-D barcode. The POS terminal will use its onboard 2-D barcode scanner to read the payment token from the 2-D barcode and use the data contained within to form a payment transaction request to the eCache Payment Gateway 82.

The design of the payment token security relies on the use of encryption technologies combined with the use of unique pseudo-random one-time use payment codes. Each payment token uses a unique, pseudo-random, one-time use payment code that is kept private until time of use on the handset, and is only known by the eCache Account Management System and the Handset Application. Whenever a customer is about to make a payment using his or her handset, the payment code is assembled along with all of the other data required to make a valid payment token. Once this has been created, the data of the payment token is then run through an encryption process used to guarantee the authenticity of the payment token.

Once the Payment Token has gone through the encryption process, it is then encoded into a 2-D barcode and becomes available for presentation on the screen of the customer's handset's. At this point, any copy of this barcode may be used at one of the specified merchant's POS terminals to process a payment one time. All subsequent transaction requests using the same payment token will be declined.

Within the eCache server, the encryption key is stored securely and is available for use when validating payment tokens of inbound payment transaction requests.

Upon successfully validating the pairing credentials presented by the handset, the Handset Control Server 90 distributes a security token to the mobile application 80. The mobile application stores this security token in the private encrypted store of the handset 89. The security token is then presented to the Handset Control Server 90 by the mobile application on all future communications and is used for identification and authorization.

A hash-based message authentication code (HMAC) is used to guarantee that the payment token has not been altered or created by a non-trusted third party. The contents of the payment token (without-HMAC) are processed through an encryption algorithm which uses a secret, unique encryption key known only to the handset and to the eCache Account Management Server. The result of this encryption process is a cryptographic hash—a series of bytes used to uniquely identify the integrity of the data. This cryptographic hash can loosely be considered the payment token's “digital thumbprint”.

When using the same encryption key, the same encryption scheme and same data to generate this hash, the same cryptographic hash (HMAC) will be generated every time. In the event that the original data has been altered in any way, the cryptographic hash will be altered as well, and thus, will not match the other cryptographic hash, indicating it has been altered. When the eCache Management Server attempts to verify the payment token as genuine and unaltered, it will perform the same cryptographic hashing process to the data, using the same encryption algorithm and same encryption key, as indicated from the pairing number in the payment token. If the eCache Account Management Server is able to create an identical HMAC, then the data is trusted, otherwise, the eCache Account Management Server cannot trust this data. Only the bearer of a valid encryption key can generate a valid HMAC that will be accepted by this system. After the HMAC is validated, normal account verification may continue for payment processing.

The combined use of a onetime use payment code with an HMAC encoded in a onetime use 2-D barcode to close a financial transaction creates a secure method to close a financial transaction.

Secure tokens may encrypt certain data elements and allow other data elements to remain in clear text. The customer's personal and financial information is stored on the Account Management Server at eCache. The eCache server authenticates the secure tokens and releases information to create 2-D barcodes at the customer's request. If the token exchanges are interrupted or if someone attempts to inject an invalid barcode or tamper with the data exchange the application is rendered invalid.

In a preferred embodiment, the mobile application may also partially format (or “preformat”) an ACH transaction on the smart phone. Upon receiving tokens from the eCache server, or upon accessing or generating them internally, the application positions encrypted tokens in the preformatted ACH data fields pertaining to necessary financial and personal information necessary to process an ACH. During scanning, the preformatted and fulfilled ACH data fields are transmitted to the retailer's POS as a 2-D eCache barcode for further processing or transmission to the eCache server where the retail transaction data and merchant data may be retrieved and loaded into the preformatted ACH data fields.

To use the smart phone to make a financial transaction, a customer opens his or her eCache application on the smart phone by touching the eCache icon on the smart phone. This is shown in FIG. 10. The eCache application cannot be opened without the successful entry of a preselected personal alphanumeric code (PIN or PAN) that the customer establishes in the customer's value profile. This is shown in FIG. 11.

In one embodiment shown in FIG. 15, a customer making a purchase at a store would select the eCache icon through the virtual ATM, or from a different link. The customer would then enter a personal alphanumeric code (PIN), as in FIG. 11. The customer may have registered to use eCache at a number of merchants. The customer selects the merchant from a list of participating merchants, as shown in FIG. 16 The customer may have previously established a value profile to be used at a particular store that gives greater reward points for a transaction that does not involve a debit or credit card for settlement. In this example, the customer could specify that a specific DDA account would be used to settle the transaction. In this manner, the customer would be able to control how each transaction would clear or settle. The eCache system may also be configured to maintain track of and to allocate a given merchant's loyalty program points for use in a particular purchase. Thus a customer can also preset a preference for the use of any earned loyalty points for a purchase.

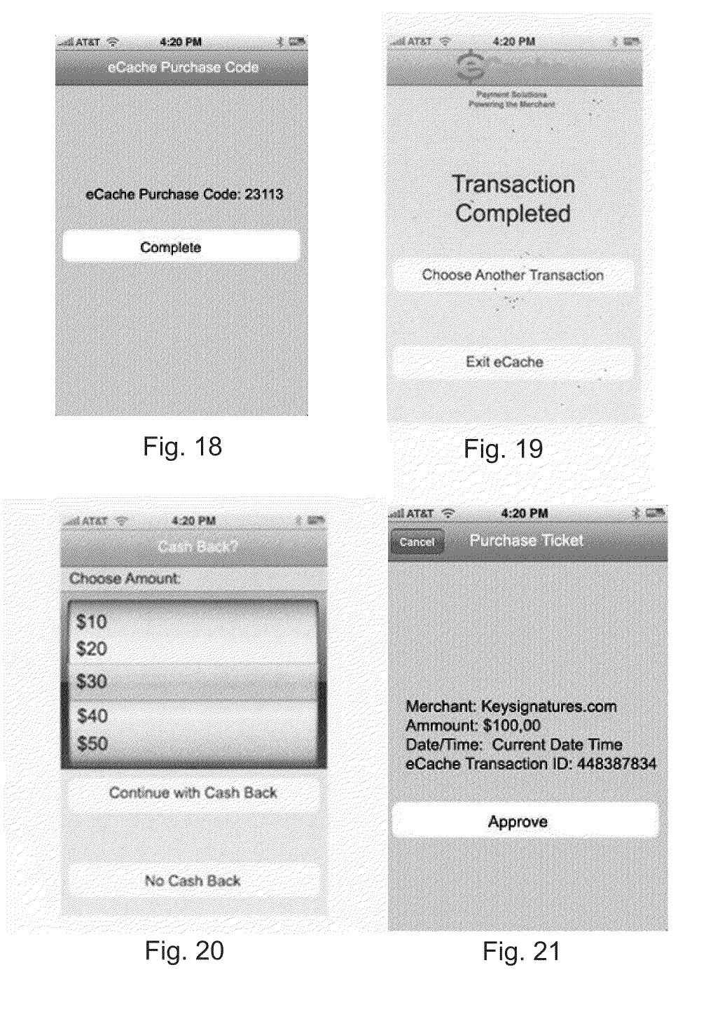

A preferred embodiment of the concept is illustrated in a number of figures. When the customer has presented a series of items for purchase at the point of sale he or she will access the eCache platform, shown in FIG. 10, through a smart phone by using his or her PAN FIG. 11. The customer has previously enrolled with eCache. eCache accesses the customer's profile, which may include such preferences as allocating reward points or coupons to the clear the sale and might include identifying a specific route to settle the transaction, say from a checking account or by executing an ACH transaction, and asked the customer to identify the merchant FIG. 16. A 2-D barcode is then generated by eCache, FIG. 17, which has included information from the user's profile. The barcode may also include instructions from the merchant as well with regards to settling the transaction. At the point of sale, the 2-D barcode is scanned and the sale is closed FIGS. 18 and 19.

The eCache application on the smart phone may link to an external eCache server to prefetch customer data (such as a value profile) to create a barcode, or may use information contained within the eCache application stored on the smart phone to generate a transaction specific 2-D barcode that may contain a security token that the customer then presents at a point of sale. The 2-D barcode has encoded detailed information concerning the transaction which may include designating particular accounts through which a transaction may be settled and allocating rewards points to be used in connection with settling the transaction. The 2-D barcode may further reflect in-store coupons or other promotions that may also be part of the settlement of the transaction.

The eCache application downloaded by the customer has an optional virtual ATM application. The virtual ATM allows the customer to create a specific instant value profile that identifies various accounts from which the customer may choose to transfer funds and monitor and/or exchange reward points from customer loyalty programs. The virtual ATM allows the customer to select the eCache account from an icon and to use that account in executing a purchase. Additionally the customer can select to have a request for cash added to the final transaction amount, as shown in FIGS. 20 and 21. This cash back feature is only available when using the virtual ATM. The virtual ATM allows a customer to manage his or her eCache DDA and monitor or convert various loyalty or rewards points that customers earn by shopping at particular stores or using particular accounts to clear a given transaction. Another embodiment of the virtual ATM is the use of a line of credit, a payday loan, micro loan or any type of consumer loan as a method to load value for merchant's transaction settlement with eCache. In one embodiment of the invention, an eCache customer may select the ATM function and instruct the ATM to issue “cash back” of $100.00. This “cash back” is drawn against a credit line linked back to an alliance partner of eCache that accepts the credit risk of the transaction and refunds the cash advance to the merchant overnight and accepts the liability of collecting the cash draw from the customer on terms and conditions accepted in a pre-registration phase with that customer authorizing a credit facility at the specific merchants POS. In effect, the cash register draw becomes the ATM but the transaction is not an EFT draw back to the customer's DDA rather it's a draw against the credit line of the customer and eCache's credit line alliance partner.

Another embodiment of the invention depicted in FIG. 15 transforms internet sales transactions. Today the internet is the fastest growing segment in the retail industry. Many customers are reluctant to shop on the internet for privacy reasons. Consumers are concerned that their personal contact information given to merchants to fulfill shipping requests will not remain secure or private. This information includes their email address, home address, phone number and other private information. Consumers are most concerned about releasing their financial information such as credit, debit or checking account information to a merchant to complete, settle or close a financial transaction.

In this embodiment, a customer would shop as he or she normally would, but at the time of check out the customer selects the eCache logo for payment. The merchant's website opens the eCache merchant application. The eCache website application prompts the customer to enter a transaction code. The customer opens the eCache application resident on his or her smart phone or accesses it via the web. The eCache application requests the customer enter their PIN number. Once the PIN has been successfully entered, the customer would select an ecommerce transaction from the menu options. The smart phone application communicates with the eCache server and if the customer is in good standing the eCache server sends a secure transaction token in the form of a unique code to the customer on their smart phone.

The customer enters the code transaction token into the eCache application resident on the merchant's website. The eCache application resident on the merchant's website receives the code transaction token and appends transaction information such as the total sale amount and a description of the purchase and encrypts a new token. The merchant website communicates with eCache central server which receives the new token. The eCache central server de-encrypts the new token. eCache matches the customer to the merchant by matching the de-encrypted transaction code received from the merchant website to the customer who requested the code on their smart phone.

The eCache central server verifies the integrity of the data. If confirmed, the eCache central server returns a secure token to the customer's smart phone which contains the merchant name, the amount of the sale, a transaction id, date and time and the description to the customer's eCache smart phone application. The smart phone token is de-encrypted and the eCache smart phone application requests that the customer confirm the merchant name, the amount of the sale and the description. The customer accepts or declines the transaction and a secure token is created and sends the response to the eCache central server.

If the customer accepts the transaction the eCache central server uses the customer's preloaded payment preferences to obtain an authorization from the eCache central server which approves or declines the transaction. If the transaction is approved the central server uses the customers stored payment method (funding source) to complete the purchase transaction with the merchant. eCache then sends a confirmation to the merchant to complete the purchase and a confirmation secure token to the customer's smart phone who requested the transaction. The eCache smart phone application will display the message and if successful it will emit the eCache transaction payment tone. If the transaction is declined the merchant and the customer are notified and the customer may open their eCache payment profile and change the funding source to attempt another authorization. Alternatively the customer may wish that eCache send an SMS message or an email message to confirm details of the transaction. Such notifications would include approval or declines, delivery time tracking numbers and the like. The customer can also request that the merchant send status emails to confirm transactions, delivery times, download information, confirmation numbers, tracking numbers and the like.

Since the eCache server contains the customer's shipping information, in situations where the actual shipper is not the merchant but instead is a third party, the eCache server communicates the shipping information directly to the shipper rather than the merchant. If the customer's purchase is electronic media that can be downloaded, the merchant will not receive any customer information and the customer remains completely anonymous. If the merchant is the shipper, eCache can sent the merchant the minimum information needed to ship the purchases. Since eCache forwards the shipping information to the shipper, the customer did not need to enter any payment account information, contact, or shipping information. By reducing the need to enter large amounts of data to complete purchases, customers can reduce the time it takes to complete internet transactions.

Having fully described the invention herein, it is to be understood that the invention is not limited to the specific embodiments described, but only be the claims appended hereto.

What is claimed:

1. A system for facilitating transactions between a customer, a merchant, and a source from which the transaction will be financed comprising:
a point of sale (POS) terminal comprising a barcode scanner, a server having a processor and storage, a smart phone capable of executing mobile applications, a source of funding a transaction, encryption and decryption means, and a network connecting said server,
said smart phone, said POS terminal, said source of funding, and the Internet, said storage receiving and storing customer information as a value profile associated with
said customer and said smart phone,
said storage receiving and storing said customer's purchasing history;
said encryption means encrypting said value profile and said purchasing history;
said processor creating a 2-D barcode comprising said encrypted value profile and purchasing history;
smart phone associated with said customer being pair with said server;
said server sending said 2-D barcode to said smart phone;
said smart phone displaying said 2-D barcode on a display;
said POS scanning said 2-D barcode;
said POS receiving additional information related to a transaction;
said POS transmitting said 2-D barcode and said additional information to said server;
said encryption and decryption means decrypting said 2-D barcode to retrieve said value profile;
said server authenticating the customer as authorized to conduct said transaction;
said server routing information regarding said transaction to said source of funding;
said server notifying said customer and said POS that said transaction has been settled.

2. A system for facilitating transactions between a customer and a merchant, comprising:
a network comprising a point of sale (POS) terminal having a barcode scanner, a server, a smart phone, and a connection between said server, said smart phone, said POS terminal, and the Internet:
said smart phone accessing information regarding a customer and authenticating said information with said server;
said smart phone accessing a primary barcode associated with said customer;
said smart phone accessing an extension barcode associated with a merchant;
said smart phone combining said primary barcode and said extension barcode into a 2-D combined barcode;
said smart phone displaying said combined barcode;
said POS barcode scanner scanning said display of said combined barcode in a single pass;
said POS sending said scanned combined barcode to said server via the Internet;
said server authenticating, authorizing, clearing and settling said transaction.

3. On a network comprising a point of sale (POS) terminal, a proprietary server, a smart phone, and a connection between said proprietary server, said smart phone, said POS terminal, and the Internet, a method of making a financial transaction comprising the steps of:
enrolling a customer, receiving said customer's information, and storing said customer's information as a value profile on a proprietary server;
compiling information regarding said customer's purchasing history;
encrypting said value profile and said customer's purchasing history and creating a 2-D barcode containing said encrypted value profile and purchasing history;
pairing a smart phone associated with said customer with said proprietary server;
sending said barcode to said smart phone;
displaying said 2-D barcode on a display of said smart phone;
scanning said 2-D barcode at said POS;
transmitting said 2-D barcode to said proprietary server;
decrypting said 2-D barcode to retrieve said value profile and said purchasing history;
associating said value profile with a financial transaction;
routing information regarding said financial transaction to a source of funding;
authorizing said financial transaction;
settling, clearing, and closing said financial transaction.

4. On a network comprising a point of sale (POS) terminal, a proprietary server, a smart phone, and a connection between said proprietary server, said smart phone, said POS terminal, and the Internet, a method of making a financial transaction comprising the steps of:
accessing information regarding a customer and authenticating said information via the Internet;
creating a primary barcode and associating said primary barcode with said customer;
creating a extension barcode and associating said primary barcode with a merchant;
combining said primary barcode and said extension barcode into a 2-D combined barcode;
displaying said combined barcode on a smart phone display;
scanning said display of said combined barcode at said POS in a single pass;
sending said scanned combined barcode to said proprietary server via the Internet;
authenticating, authorizing, clearing and settling a retail transaction of exchange of one or more of credit, debit, prepaid account, reward, loyalty points, and coupons.

5. On a network comprising a point of sale (POS) terminal, a proprietary server, a customer's value profile maintained on said proprietary server, a smart phone associated with said customer's value profile, said smart phone having global satellite positioning information, and a connection between said proprietary server, said smart phone, said POS terminal, and the Internet, a method of distributing coupons comprising the steps of:
determining and storing a GPS location of a POS terminals in a first merchant's store;
conducting a first financial transaction at one of said POS terminals in said first merchant's store;
determining the GPS location of said first financial transaction during an authorization phase of said transaction;
accessing said value profile associated with a customer;
displaying on said smart phone a time-limited coupon for a purchasing an item at a second merchant's store where said second merchant's store is in proximity to said determined GPS location and wherein said first time-limited coupon is selected based upon said customer's value profile;
conducting a second financial transaction at said second merchant's store, said second financial transaction comprising purchasing said item, said purchase comprising redeeming said time-limited coupon and paying any additional amount owing through an ACH transaction.

6. On a network comprising a point of sale (POS) terminal, a proprietary server, a smart phone having global satellite positioning information, and a connection between said proprietary server, said smart phone, said POS terminal, and the Internet, a method of making a financial transaction comprising the steps of:
creating a secure encrypted token that partially formats an ACH transaction on a customer's smart phone;
pairing said smart phone to said proprietary server through the eCache application and;
scanning said pre formatted and fulfilled ACH data fields to a retailer's POS as a 2D barcode where information associated with a retail transaction is loaded into said pre formatted ACH data fields;
transmitting said formatted ACH to said proprietary server;
forwarding said formatted ACH to an Originating Depositary Financial Institution (ODFI) for processing said ACH.
